(19) United States
(12) Patent Application Publication
(10) Pub. No.: US 2003/0182229 A1
(43) Pub. Date: Sep. 25, 2003

(54) Method and apparatus for web-based consumer financing

(76) Inventors: Brian M. Siegel, Washingtonville, NY (US); Jack Halperin, River Vale, NJ (US); Anne Vesce, Montbello, NY (US); Richard G. Jenkins, Montclair, NJ (US); Erna P. Adelson, Montclair, NJ (US)

Correspondence Address: Valley Oak Law, 5655 Silver Creek Valley Road, #106, San Jose, CA, 95138, US

(21) Appl. No.: 10/360,340

(22) Filed: Feb. 6, 2003

Related U.S. Application Data
(60) Provisional application No. 60/355,455, filed on Feb. 6, 2002.

(51) Int. Cl. G06F 17/60

(52) U.S. Cl. 705/39; 705/38; 705/26

(57) ABSTRACT

Methods and apparatus are described for viewing and electing to purchase an item for the purchase price or via a financing option. In one embodiment, the invention displays a purchase price for an item and simultaneously displays financing information for the item wherein the financing information includes a monthly payment. In another embodiment, the invention displays a total purchase price for a selected group; simultaneously displays financing information for the selected group; selects an item to form part of the selected group; and updates the total purchase price and the financing information to reflect the item which is part of the selected group.

### CROSS REFERENCE TO RELATED APPLICATIONS

The application claims priority from the U.S. provisional application entitled “Web Based Consumer Financing” filed on Feb. 6, 2002, with serial No. 60/355,455, which is herein incorporated by reference.

### FIELD OF THE INVENTION

The present invention relates generally to viewing and accessing financing options and, more particularly, to viewing and accessing financing options through an electronic format.

### BACKGROUND OF THE INVENTION

Researching, selecting, and purchasing products and services through the Internet has become indispensable for many consumers. With increasing access to the Internet, more people are utilizing electronic commerce to purchase products and services for both business and leisure. Compared to traditional purchases which necessitate direct human interaction between the consumer and the merchant, electronic commerce is gaining popularity because, in part, of the immediacy of the purchase and the ease in conducting the purchase.

There are many variations of purchasing products and services through the Internet. One popular interface utilizes a shopping cart model where a symbol representing a shopping cart is shown. The shopping cart model may provide consumers with a comfortable interface for purchasing products and services. Another popular interface which is similar the shopping cart model utilizes a basket instead of a shopping cart to help consumers conceptualize purchasing products and services electronically.

Even with the various interfaces that help consumers purchase products and services electronically, these interfaces do not provide consumers with enough information to make informed purchases of products and services.

### SUMMARY OF THE INVENTION

Methods and apparatus are described for viewing and electing to purchase an item for the purchase price or via a financing option. In one embodiment, the invention displays a purchase price for an item and simultaneously displays financing information for the item wherein the financing information includes a monthly payment. In another embodiment, the invention displays a total purchase price for a selected group; simultaneously displays financing information for the selected group; selects an item to form part of the selected group; and updates the total purchase price and the financing information to reflect the item which is part of the selected group.

### BRIEF DESCRIPTION OF THE DRAWINGS

The accompanying drawings, which are incorporated in and constitute a part of this specification, illustrate one embodiment of the invention and, together with the description, explain one embodiment of the invention. In the drawings,

FIG. 1 is a diagram illustrating an environment within which the invention may be implemented.

FIG. 2 is a simplified block diagram illustrating one embodiment in which the invention may be implemented.

FIG. 3 is a flow diagram for viewing financing information, consistent with one embodiment of the invention.

FIG. 4 is a flow diagram for viewing financing information and selecting items for purchase, consistent with one embodiment of the invention;

FIG. 5 is a flow diagram for offering financing options, consistent with one embodiment of the invention.

FIG. 6 is a flow diagram for purchasing a product, consistent with one embodiment of the invention.

FIG. 7 is a screen shot illustrating product information and financing information, consistent with one embodiment of the invention.

FIG. 8 is a screen shot illustrating financing information corresponding to a selected product, consistent with one embodiment of the invention.

FIG. 9 is a screen shot illustrating a financing summary corresponding to selected products, consistent with one embodiment of the invention.

FIG. 10 is a screen shot illustrating a financing option interface for purchasing selected products, consistent with one embodiment of the invention.

FIG. 11 is a screen shot illustrating a financing option interface for purchasing selected products, consistent with one embodiment of the invention.

FIG. 12 is a screen shot illustrating a financing status interface for purchasing selected products, consistent with one embodiment of the invention.

FIG. 13 is a screen shot illustrating a financing option interface for purchasing selected products, consistent with one embodiment of the invention.

FIG. 14 is a screen shot illustrating a financing result interface for purchasing selected products, consistent with one embodiment of the invention.

FIG. 15 is a screen shot illustrating a financing result interface for purchasing selected products, consistent with one embodiment of the invention.

### DETAILED DESCRIPTION

The following detailed description of the invention refers to the accompanying drawings. The detailed description does not limit the invention. Instead, the scope of the invention is defined by the appended claims and equivalents.

The present invention includes methods and apparatus for generating and displaying financing information related to purchasing products or services. The present invention also includes methods and apparatus for offering various financing options to the consumers. In one embodiment, financing information includes a monthly payment amount and the length of term to purchase a specific item. In another embodiment, financing information includes a total monthly payment amount and the length of term to purchase multiple items. In yet another embodiment, a status bar displays the financial information for items selected for possible purchase.

Those skilled in the art will recognize that many other implementations are possible, consistent with the present invention.

A. Environment and Architecture

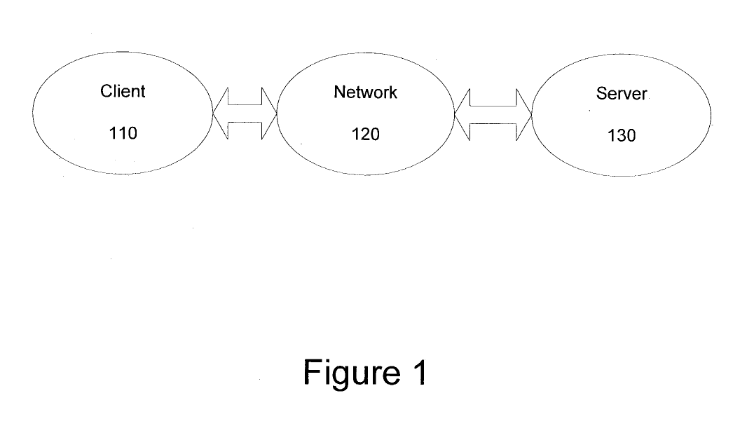

FIG. 1 is a diagram illustrating an environment within which the invention may be implemented. The environment includes a client 110, a network 120, and a server 130.

The client 110 may be the interface device for a potential consumer. The potential consumer may gather facts such as purchase price, monthly financing payments, term of financing for a corresponding product or service.

The network 120 interfaces with both the client 110 and the server 130. In one embodiment, the network 120 is the Internet. In another embodiment, the network 120 may be any transmission medium between the client 110 and the server 130.

The sever 130 is a device configured to interface with the client 110 through the messaging system 120.

The client 110 and/or the server 130 may include a combination of software, hardware, and/or firmware to provide customized financing applications.

In one embodiment, a customized financing application provides the client 110 with a purchase price and a monthly financing payment price including the term of the financing for a particular product or service. In another embodiment, the customized financing application provides a choice between a purchase price or financing terms for electronically purchasing a corresponding product through the network 120. In another embodiment, the customized financing application provides the client 110 a choice in the specific terms of financing a corresponding product or service. In another embodiment, the customized financing application provides the client 110 an opportunity to apply for financing while completing an electronic purchase through the network 120.

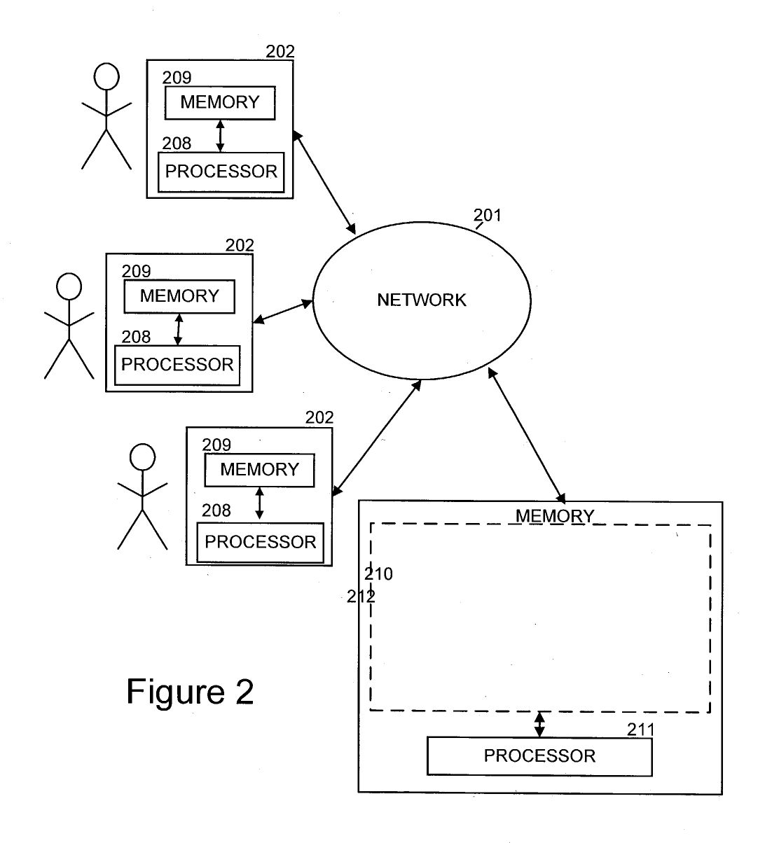

FIG. 2 is a simplified diagram illustrating an exemplary architecture in which the present invention may be implemented. The exemplary architecture includes a plurality of client devices 202, a server device 210, and a network 201. In one embodiment, the network 201 may be the Internet. The plurality of client devices 202 are each configured to include a computer-readable medium 209, such as random access memory, coupled to a processor 208. Processor 208 executes program instructions stored in the computer-readable medium 209. In another embodiment, the plurality of client devices 202 may also include a number of additional external or internal devices, such as, without limitation, a mouse, a CD-ROM, a keyboard, and a display.

Similar to the plurality of client devices 202, the server device 210 may include a processor 211 coupled to a computer-readable medium 212. The server device 210 may also include a number of additional external or internal devices, such as, without limitation, a secondary storage element, such as database 240.

The plurality of client processors 208 and the server processor 211 can be any of a number of well known computer processors, such as processors from Intel Corporation, of Santa Clara, Calif. In general, the plurality of client devices 202 may be any type of computing platform connected to a network and that interacts with application programs, such as a digital assistant or a “smart” cellular telephone or pager. The server 210, although depicted as a single computer system, may be implemented as a network of computer processors.

The plurality of client devices 202 and the server 210 may include the customized finance application. In one embodiment, the plurality of computer-readable medium 209 and 212 may contain, in part, the customized finance application. Additionally, the plurality of client devices 202 and the server 210 are configured to receive and transmit electronic messages for use with the customized finance application. Similarly, the network 201 is configured to transmit electronic messages for use with the customized finance application.

B. Operation

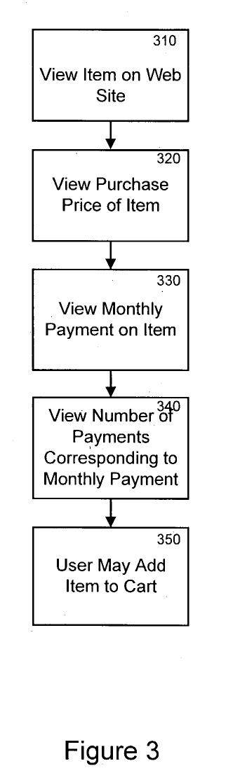

The flow diagrams as depicted in FIGS. 3, 4, 5, and 6 are merely embodiments of the invention. In each embodiment, the flow diagrams illustrate the use of the customized finance applications.

The blocks within the flow diagram may be performed in a different sequence without departing from the spirit of the invention. Further, blocks may be deleted, added, or combined without departing from the spirit of the invention.

The flow diagram in FIG. 3 illustrates viewing financing information from a customized finance application according to one embodiment. In Block 310, an item is shown on a client device for potential purchase. In one embodiment, the item is a product. In another embodiment, the item is a service.

In Block 320, among other information relating to the item for purchase, a purchase price for the item is shown on the client device.

In Block 330, among other information relating to the item for purchase, a monthly payment amount is shown on the client device. In one embodiment, the monthly payment amount corresponds to the amount of money required to be paid monthly for the related item. In another embodiment, monthly payment amount corresponds to the minimum amount of money required to be paid monthly for the related item.

In Block 340, among other information relating to the item for purchase, a number of monthly payments is shown on the client device. In one embodiment, the number of monthly payments amount corresponds to the number of monthly payments to purchase the related item at the monthly payment amount shown in the Block 330.

In Block 350, a user of the client device may make an informed purchase and place the item in the user's cart. In one embodiment, the client device has displayed financial information such as the purchase price of the item, the monthly payment if the item is financed, and the number of months the monthly payments are based upon.

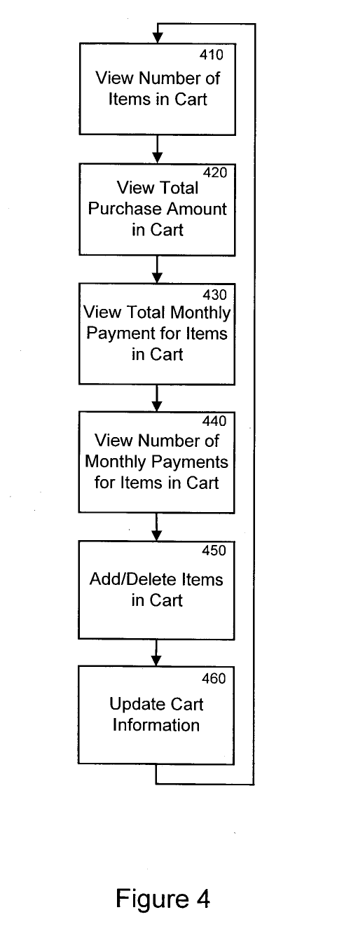

The flow diagram in FIG. 4 illustrates viewing financing information from a customized finance application according to one embodiment. In Block 410, the number of items within a shopping cart are shown on a client device for potential purchase. At any given moment in time, the number of items within the shopping cart may be from 0 to N wherein N represents any integer. In one embodiment, the item is a product. In another embodiment, the item is a service.

In one embodiment, a shopping cart model is utilized for exemplary purposes to represent the items which a user of the client device identifies for possible purchase. In another embodiment, an alternate model may be utilized to represent the items which a user of the client device identifies for possible purchase.

In Block 420, the total purchase amount corresponding to items within the shopping cart are shown on the client device. For example, there are 2 items within the shopping cart; the first item is $100, and the second item is $200. In this example, the total purchase amount shown on the client device would be $300.

In Block 430, the total monthly payment amount corresponding to items within the shopping cart are shown on the client device. In Block 440, the number of monthly payments which corresponds to the total monthly payment amount is shown on the client device.

In Block 450, an item may be added to or deleted from the shopping cart. The items remaining in the shopping card are identified for possible purchase by the user of the client device.

In Block 460, the number of items as displayed in the Block 410 are updated in response to the Block 450. Similarly, the total purchase amount as displayed in the Block 420 are updated in response to the Block 450. Similarly, the total monthly payment as displayed in the Block 430 are updated in response to the Block 450. Similarly, the number of monthly payments as displayed in the Block 440 are updated in response to the Block 450.

The number of items, the total purchase amount, the total monthly payment, and the number of monthly payments may be dynamically adjusted based on changes to the items within the shopping cart within the Block 450.

The number of items and the total purchase amount may be directly calculated from the changes within the Block 450. The total monthly payment and the number of monthly payments may be adjusted together. For example, if the total purchase amount is above X amount, then the number of monthly payments may be 48 months. The total monthly payment is then calculated based on the 48 monthly payments. In another example, if the total purchase amount is below X amount, then the number of monthly payments may be 12 months. The total monthly payment is then calculated based on the 12 monthly payments.

After the information is updated in the Block 460, the updated information may be displayed by returning back to the Block 410.

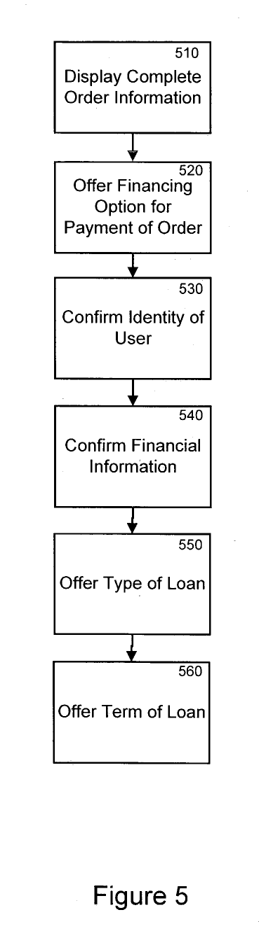

The flow diagram in FIG. 5 illustrates viewing financing information from a customized finance application according to one embodiment. In Block 510, the complete order information is shown on a client device for purchase. The complete order information may include identifying the items identified for purchase, the number of items identified for purchase, the total purchase amount, the total monthly payment, and the number of monthly payments.

In Block 520, a financing option is presented to the client device.

In Block 530, the identity of the user of the client device is confirmed. In one embodiment, the client device authenticates the identity of the user by receiving a password. In another embodiment, the client device authenticates the identity of the user by receiving a biometric parameter such as a finger print.

In Block 540, the financial information corresponding to the user of the client device is confirmed. In one embodiment, the financial information is confirmed by requesting a series of financial questions.

In Block 550, the type of loan is offered to the user of the client device. For example, the user of the client device may be offered an interest free loan or an interest accruing loan. The type of loan and the interest rate may depend on the financial information of the user. The term loan is utilized to represent financing in terms of a revolving credit line as well as a traditional loan.

In Block 560, the length of the term of the loan is offered to the user of the client device. The length or loan term may be determined based on the type of loan selected as well as the financial information of the user.

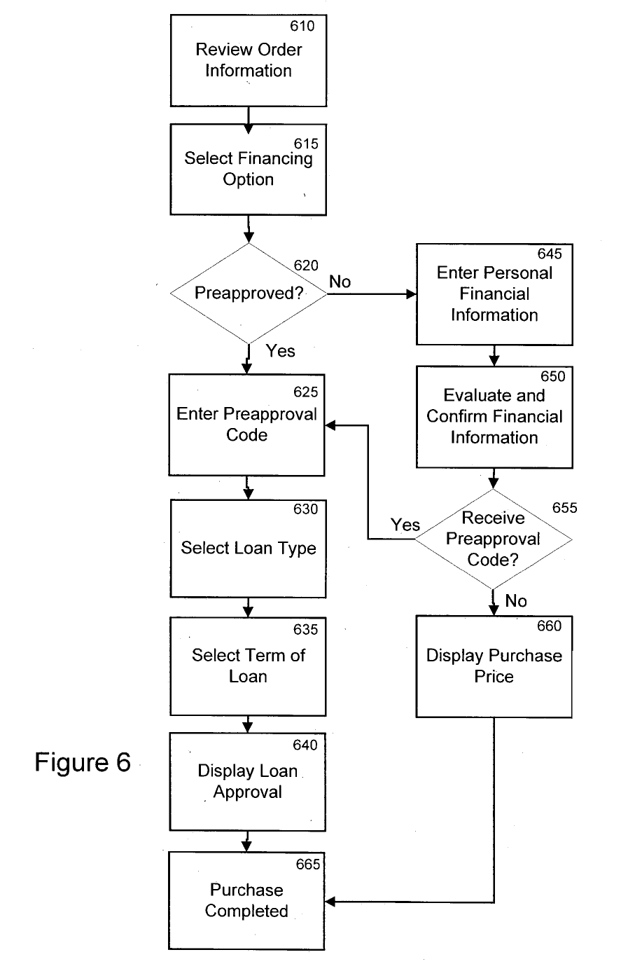

The flow diagram in FIG. 6 illustrates purchasing an item based on viewing financing information from a customized finance application according to one embodiment. In Block 610, the complete order information is shown on a client device for purchase for review by the user of the client device. The complete order information may include identifying the items identified for purchase, the number of items identified for purchase, the total purchase amount, the total monthly payment, and the number of monthly payments.

In Block 615, financing options are able to be selected by the user.

In Block 620, the customized financing application determines whether the user has been pre-approved for financing the purchase of selected items as shown in the Block 610.

If the user has not been pre-approved, the user enters personal financial information in the Block 645. The personal financial information may include social security number, current monthly income, current monthly debt, and the like.

If the user is pre-approved, the user is asked to enter the pre-approval code in the Block 625.

In Block 650, based on confirmation and evaluation of the personal financial information, the customized financing application selectively issues a pre-approval code for the user.

In Block 655, the customized financing application checks for the pre-approval code. If the pre-approval code has been received by the user of the client device, then the user is asked to enter the pre-approval code in the Block 625. If the pre-approval code is denied to the user, then the user is given an option to purchase the selected items in the Block 660 for the total purchase amount shown in the Block 610.

In Block 630, the type of loan is selected by the user of the client device. For example, the user of the client device may be offered an interest free loan or an interest accruing loan. The type of loan and the interest rate may depend on the financial information of the user. The term loan is utilized to represent financing in terms of a revolving credit line as well as a traditional loan.

In Block 635, the length of the term of the loan is offered to the user of the client device. The length or loan term may be determined based on the type of loan selected as well as the financial information of the user.

In Block 640, the customized financing application evaluates the loan type and loan term and displays the loan approval information. In one embodiment, the loan approval information includes the total purchase price, the monthly payment amount, the term of the monthly payments, the interest rate, and the like.

In Block 665, the purchase of the selected items as shown in the Block 610 is completed. In one embodiment, the selected items are purchased via financing as shown in the Blocks 620 through 655. In another embodiment, the selected items are purchased directly as shown in the Block 660.

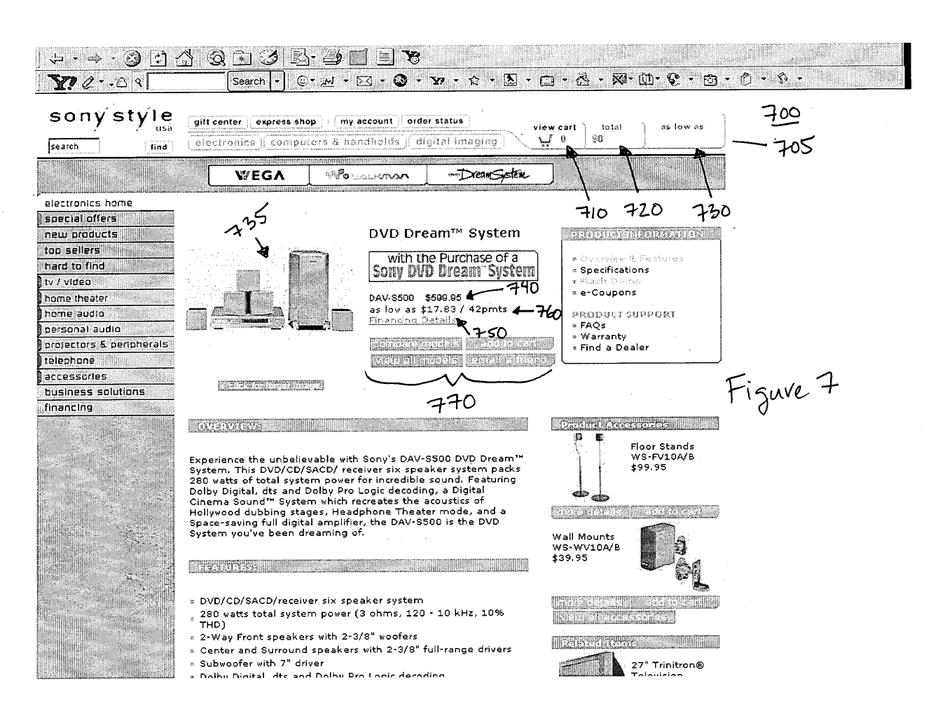

FIG. 7 shows a sample screen shot 700 illustrating a customized financing application according to one embodiment of the invention. The screen shot 700 is configured to allow a user to learn more about items for purchase. The screen shot 700 displays a status bar 705 and a displayed item 735. The status bar 705 includes an item count 710, a total purchase amount 720, and financing terms 730. The item count 710 is shown as zero which represents that no items have been identified for possible purchase at this time. Accordingly, the total purchase amount 720 is also zero. The financing terms 730 are blank as well.

The displayed item 735 includes a picture of the item, the purchase price of the item 740, the monthly payment amount for the item 750, the number of months for the monthly payment 760, and various other control buttons 770.

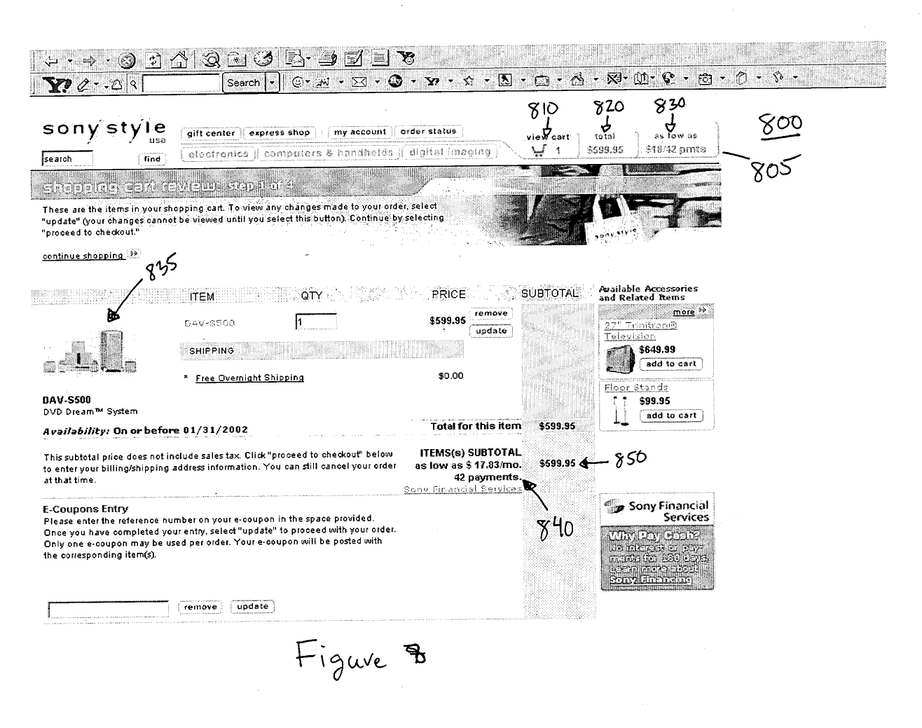

FIG. 8 shows a sample screen shot 800 illustrating a customized financing application according to one embodiment of the invention. The screen shot 800 is configured to allow a user to review an item intended for possible purchase. The screen shot 800 displays a status bar 805 and a displayed item 835. The status bar 805 includes an item count 810, a total purchase amount 820, and financing terms 830. The item count 810 is shown as “1” which represents that a single item has been identified for possible purchase at this time. In this example, the item 835 has been selected. Accordingly, the total purchase amount 820 is $599.95. The financing terms 830 shows that 42 payments at $18 per payment is estimated if financing the item intended for purchase is desired. In one embodiment, the status bar 805 including the item count 810, the total purchase amount 820 and the financing terms 830 may be constantly displayed while the user continues to shop for other items.

In addition to the status bar 805, financing terms 840 and the total purchase amount 850 are also displayed in a purchase summary which includes the item 835.

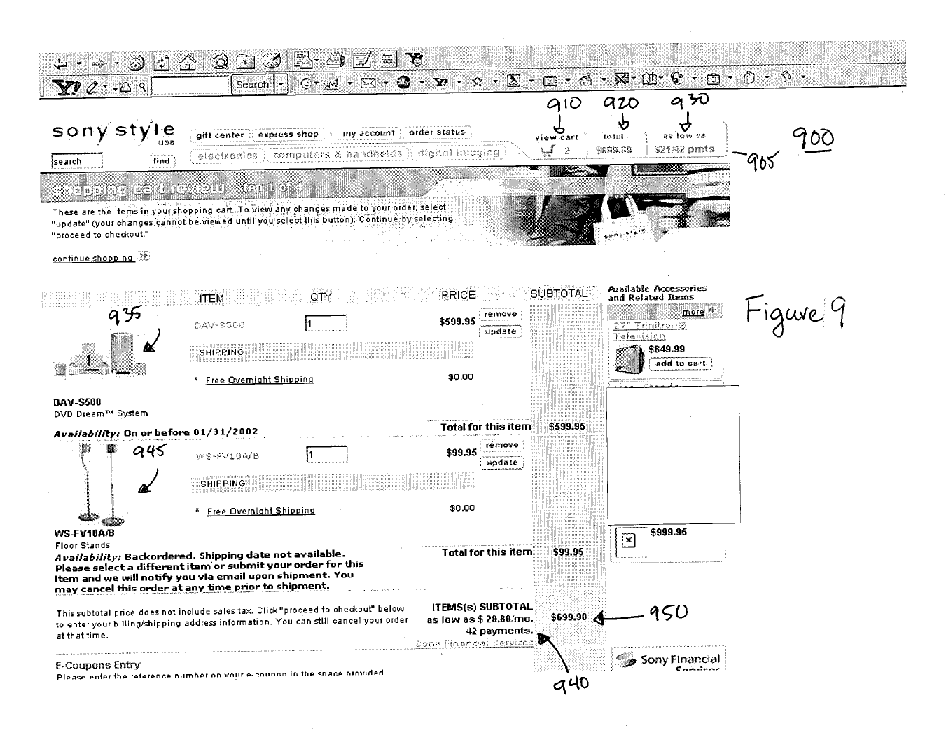

FIG. 9 shows a sample screen shot 900 illustrating a customized financing application according to one embodiment of the invention. The screen shot 900 is configured to allow a user to review an item intended for possible purchase. The screen shot 900 displays a status bar 905 and displayed items 935 and 945. The status bar 905 includes an item count 910, a total purchase amount 920, and financing terms 930. The item count 910 is shown as “2” which represents that two items have been identified for possible purchase at this time. In this example, the items 935 and 945 have been selected. Accordingly, the total purchase amount 920 is $999.90. The financing terms 930 shows that 42 payments at $21 per payment is estimated if financing the items intended for purchase is desired. In one embodiment, the status bar 905 including the item count 910, the total purchase, amount 920 and the financing terms 930 may be constantly displayed while the user continues to shop for other items.

In addition to the status bar 905, total financing terms 940 and the total purchase amount 950 are also displayed in a purchase summary which includes the items 935 and 945.

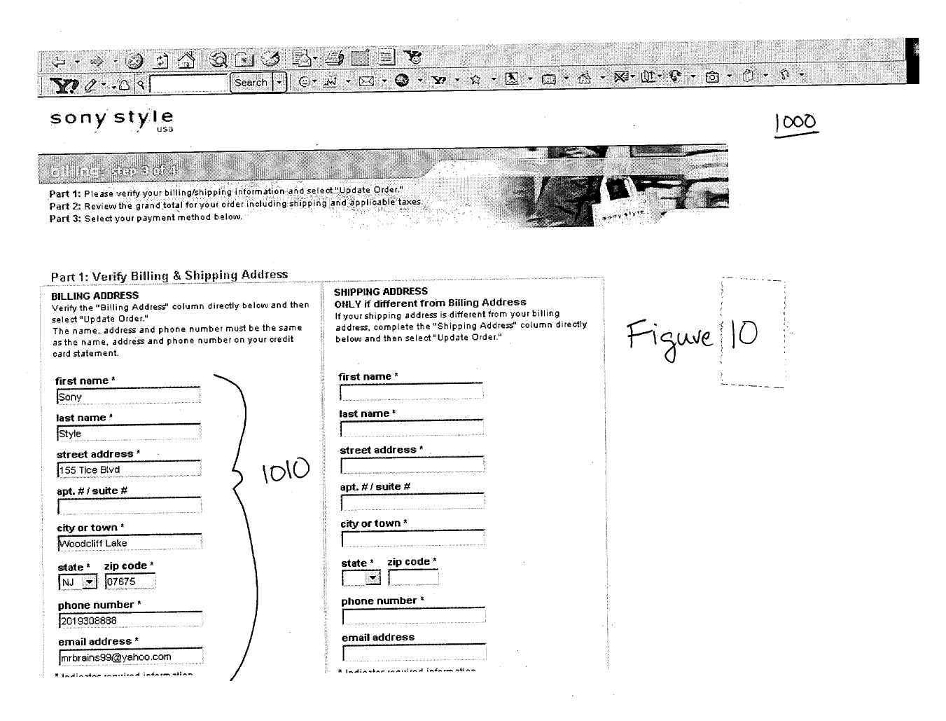

FIG. 10 shows a sample screen shot 1000 illustrating a customized financing application according to one embodiment of the invention. The screen shot 1000 is configured to allow a user enter billing information in fields 1010.

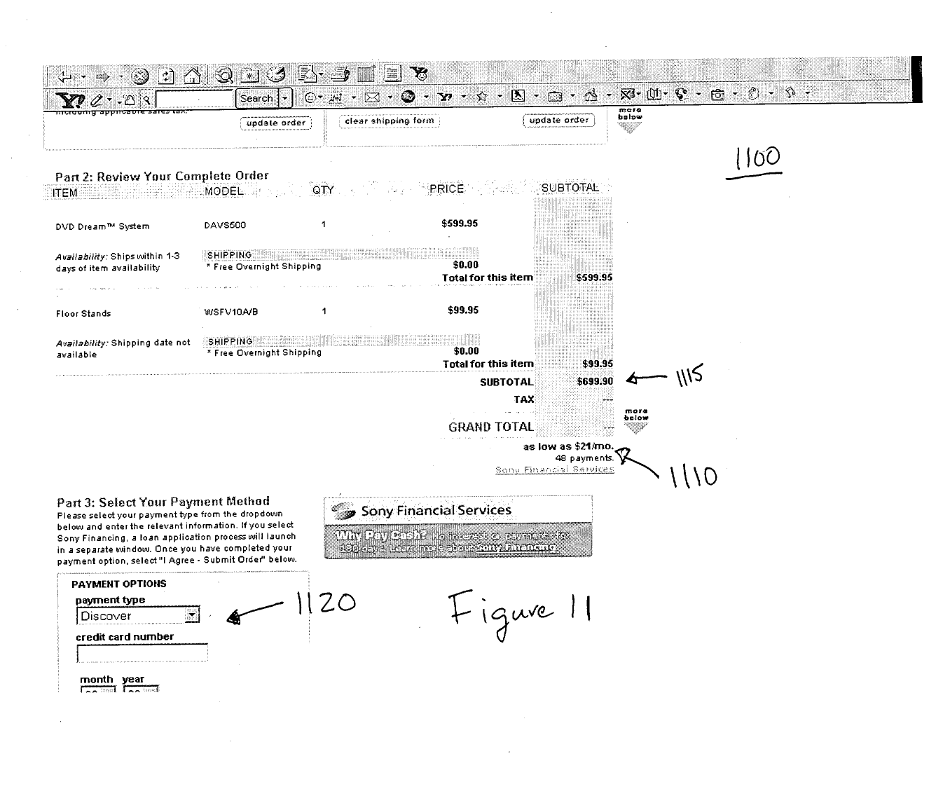

FIG. 11 shows a sample screen shot 1100 illustrating a customized financing application according to one embodiment of the invention. The screen shot 1100 is configured to allow a user to review financing information 1110 and total purchase price 1115. The screen shot 1100 also allows the user to select different payment options at the payment selector 1120.

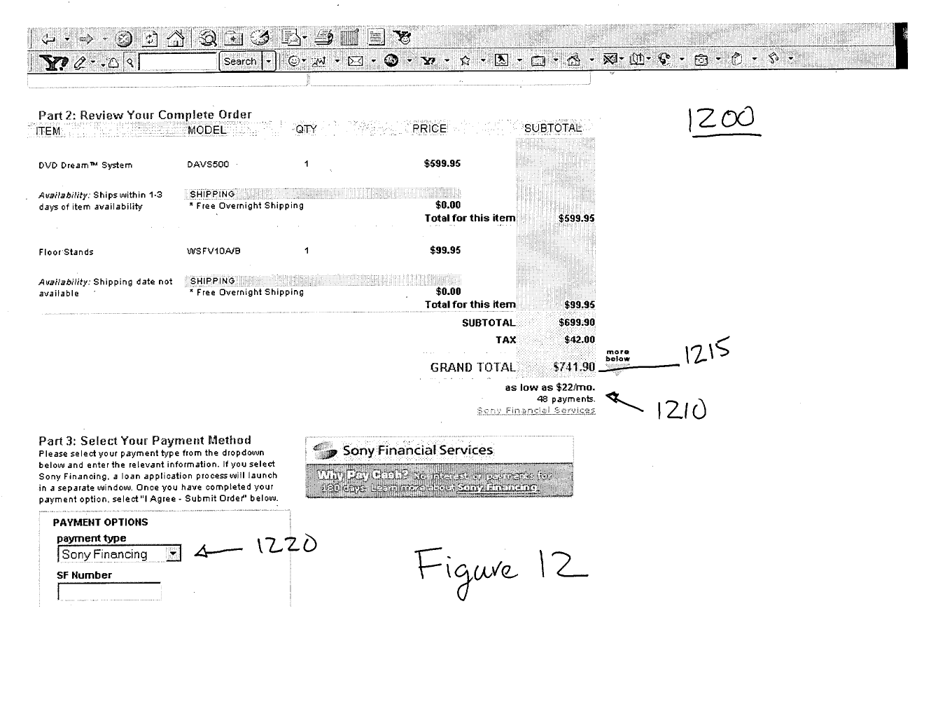

FIG. 12 shows a sample screen shot 1200 illustrating a customized financing application according to one embodiment of the invention. The screen shot 1200 is configured to allow a user to review financing information 1210 and total purchase price 1215. The financing information 1210 and the total purchase price 1215 have been updated to include applicable taxes. The screen shot 1200 also allows the user to select different payment options at the payment selector 1220. In this example, the user selected “Sony Financing” as a payment option.

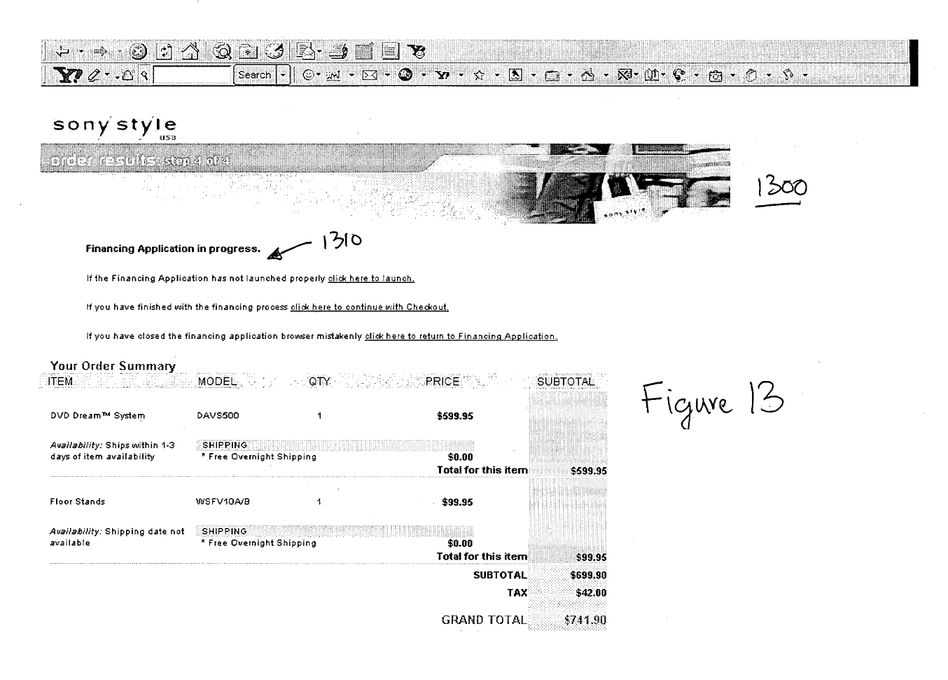

FIG. 13 shows a sample screen shot 1300 illustrating a customized financing application according to one embodiment of the invention. The screen shot 1300 is configured to update the user on financing approval for the purchase of several items as shown in financing update 1310.

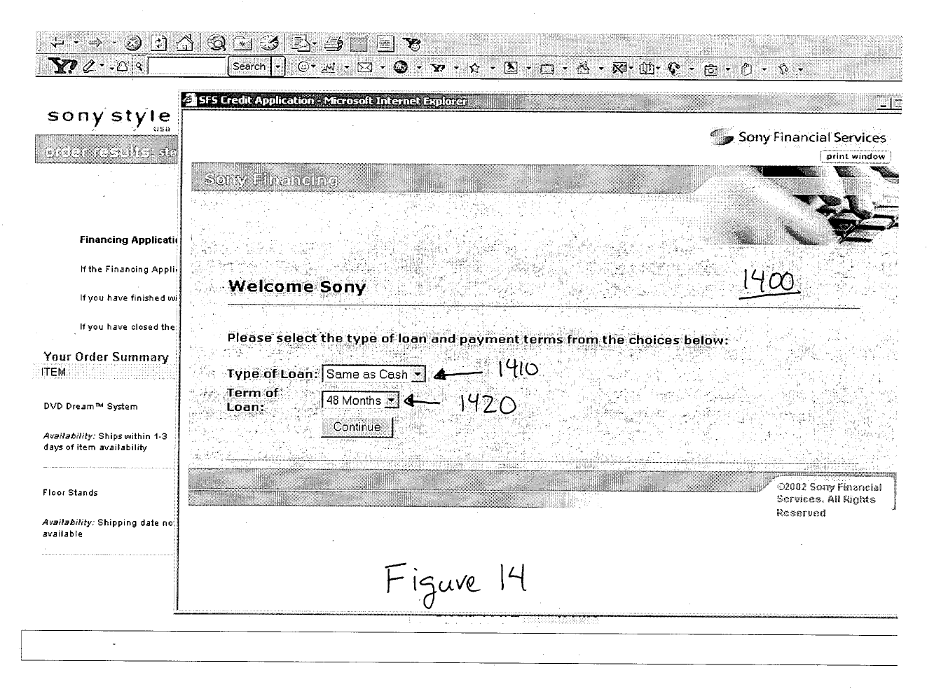

FIG. 14 shows a sample screen shot 1400 illustrating a customized financing application according to one embodiment of the invention. The screen shot 1400 is configured to allow the user to select various financing options. For example, the user may select the type of loan and the term of the loan by interfacing with loan type interface 1410 and loan term interface 1420, respectively. The loan term may be any applicable interest rate.

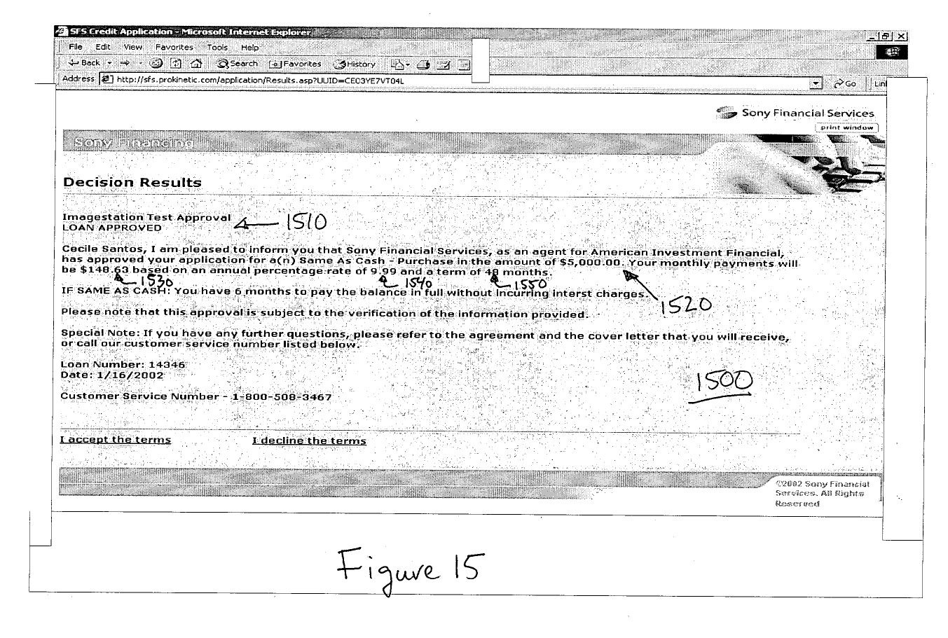

FIG. 15 shows a sample screen shot 1500 illustrating a customized financing application according to one embodiment of the invention. The screen shot 1500 is configured to update the user with financing decision results. For example, an approval field 1510 informs the user if the financing for the selected item(s) is approved. A purchase amount field 1520 informs the user of the purchase amount which is available to be financed. A monthly payment field 1530 informs the user the amount of the total monthly payment. An interest rate field 1540 informs the user the amount of annual interest that will be assessed. A term field 1550 informs the user how many monthly payments will be made to satisfy the financing.

### C. CONCLUSION

For the sake of clarity, the foregoing references to “loans” also includes financing, revolving credit, and equivalents for describing a series of payments for acquiring a product or service.

Further, the foregoing references to “financing” in the embodiments are shown for exemplary purposes and are not intended to limit the invention. Financing includes any type of periodic payment for a duration of time such as but not limited to periodic cash payments. Although financing may include receiving interest in addition to the principle, financing does not necessarily involve any interest payments.

The foregoing descriptions of specific embodiments of the invention have been presented for purposes of illustration and description. For example, the invention is described within the context of purchasing products as merely one embodiment of the invention. The invention may be applied to a variety of other applications such as purchasing services and the like.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A method comprising:
displaying a purchase price for an item; and
simultaneously displaying financing information for the item
wherein the financing information includes a monthly payment.

2. The method according to claim 1 wherein the financing information further comprises a number of months corresponding to the monthly payment.

3. The method according to claim 1 further comprising purchasing the item based on selecting the financing information.

4. A method comprising:
displaying a total purchase price for a selected group;
simultaneously displaying financing information for the selected group;
selecting an item to form part of the selected group; and
updating the total purchase price and the financing information to reflect the item which is part of the selected group.

5. The method according to claim 4 wherein the financing information includes a monthly payment.

6. The method according to claim 4 wherein the financing information includes a predetermined number of months.

7. The method according to claim 4 wherein the financing information comprises a portion of a status bar.

8. The method according to claim 4 wherein the total purchase price comprises a portion of a status bar.

9. The method according to claim 4 further comprising displaying a number of items within the selected group.

10. The method according to claim 4 wherein the selected group represents items which are selected for possible purchase.

11. The method according to claim 4 wherein the selected group represents items which are within a shopping cart model.

12. A method comprising:
displaying a total purchase price for a selected group;
simultaneously displaying financing information for the selected item;
removing an item from the selected group;
updating the total purchase price and the financing information to reflect removal of the item from the selected group.

13. The method according to claim 12 wherein the financing information includes a monthly payment.

14. The method according to claim 12 wherein the financing information includes a predetermined number of months.

15. The method according to claim 12 wherein the financing information comprises a portion of a status bar.

16. The method according to claim 12 wherein the total purchase price comprises a portion of a status bar.

17. A method comprising:
displaying a total purchase price for an item;
simultaneously displaying financing information for the item;
offering a plurality of loan types; and
offering a loan term based on the total purchase price and a selected loan type.

18. The method according to claim 17 wherein the financing information includes a monthly payment.

19. The method according to claim 17 wherein the financing information includes a predetermined number of months.

20. The method according to claim 17 wherein one of the plurality of loan types is an interest free loan.

21. The method according to claim 17 wherein one of the plurality of loan types is a loan with a predetermined interest rate.

22. The method according to claim 17 further comprising approving a purchase of the item by financing the item for a selected loan type and the loan term.

23. The method according to claim 23 further comprising displaying a loan approval for the purchase of the item with the selected loan type, the loan term, and a monthly payment amount.

24. A computer-readable medium having computer executable instructions for performing a method comprising:
displaying a total purchase price for an item;
simultaneously displaying financing information for the item;
offering a plurality of loan types; and
offering a loan term based on the total purchase price and a selected loan type.
